(19) United States
(12) Patent Application Publication
(10) Pub. No.: US 2025/0377606 A1
(43) Pub. Date: Dec. 11, 2025

(54) EXPOSURE DEVICE AND IMAGE FORMING APPARATUS

(71) Applicant: SHARP KABUSHIKI KAISHA, Osaka (JP)

(72) Inventor: Yoshio MIZUYAMA, Osaka (JP)

(21) Appl. No.: 19/208,874

(22) Filed: May 15, 2025

(30) Foreign Application Priority Data
Jun. 11, 2024 (JP) 2024-094218

(51) Int. Cl. G03G 15/04; G03G 15/043

(52) U.S. Cl. CPC G03G 15/04054; G03G 15/043; G03G 2215/0409; G03G 2215/0412

(57) ABSTRACT

An image forming apparatus includes a panel member that opposes a photoreceptor and has plural light-emitting elements. The panel member has plural element groups, in which the light-emitting elements are arranged in a main scanning direction along a rotation axis of the photoreceptor. Each of the element groups includes: forward order arrangement in which the plural light-emitting elements are arranged such that positions thereof in a sub-scanning direction orthogonal to the main scanning direction are shifted from one end side to the other end side toward one side in the main scanning direction; and reverse order arrangement in which the plural light-emitting elements are arranged such that positions thereof in the sub-scanning direction are shifted from the other end side to the one end side toward the one side in the main scanning direction.

### INCORPORATION BY REFERENCE

This application claims the priority based on Japanese Patent Application No. 2024-094218 filed in Japan on Jun. 11, 2024, the entire contents of which are incorporated herein by reference in its entirety.

### BACKGROUND OF THE INVENTION

### Field of the Invention

The present disclosure relates to an exposure device including a panel member having plural light-emitting elements, and to an image forming apparatus.

### Description of the Background Art

Conventionally, electrophotographic image forming apparatuses, in which an electrostatic latent image is formed on a photoreceptor by using laser light or the like, and then the electrostatic latent image is developed, transferred, and fixed to form an image on paper, have been widely used. In recent years, a linear light source, in which point light sources such as light-emitting elements are arranged in a line, is frequently used as a light source for exposing the photoreceptor. In addition, such a method has been proposed that the plural light-emitting elements are arranged not only in a main scanning direction but also in a sub-scanning direction to increase an exposure amount or increase pixel density.

A conventional image recording apparatus for a silver halide photographic light-sensitive material has a recording head in which plural light-emitters are arranged in one or plural rows in the form of a dotted line(s), and performs preparatory light emission to cause the light-emitters of the recording head to emit the light at the time after power-on of the apparatus and before a start of image recording.

In addition, the conventional image forming apparatus includes: a light-emitting array in which light-emitting points are arranged in the main scanning direction; the photoreceptor exposed by the light-emitting array; an image former that forms the image; and a light emission controller that controls the light-emitting array. The light emission controller performs: a process to determine each light-emitting point group such that a boundary of the light-emitting point group, to which a correction value related to the sub-scanning direction is allocated, and a boundary of the light-emitting point group, to which a correction value for a light amount correction is allocated, do not overlap in the main scanning direction; and a processing to perform correction of a sub-scanning position and correction of the light amount with the light-emitting points in each of the light-emitting point groups as one unit.

Furthermore, the conventional image forming apparatus has an image writer and a controller for plural organic electroluminescent (EL) elements. The image writer is provided with plural light-emitting element lines, in each of which the plural organic EL elements are arranged for main scanning of an image carrier, in plural rows in the sub-scanning direction, and the organic EL elements are arranged two-dimensionally. The controller illuminates at least one of the organic EL elements, which form the same dotted latent image by multiple exposure, at least once during the single main scanning.

By the way, there is a case where it is difficult to arrange the light-emitting elements in a line or in a matrix due to high definition or low power consumption, and in such a case, the light-emitting elements may be shifted in a cyclic manner in the sub-scanning direction. Such arrangement causes a problem that density becomes higher than expected due to a phenomenon called reciprocity failure when the light-emitting elements that are significantly distant from each other in the sub-scanning direction expose adjacent pixels.

The present disclosure has been made to solve the above problem, and an object of the present disclosure is to provide an exposure device and an image forming apparatus capable of reducing density unevenness by suppressing a variation in an exposure time difference.

### SUMMARY OF THE INVENTION

An exposure device according to the present disclosure is an exposure device including a panel member that opposes a photoreceptor and has plural light-emitting elements, in which the panel member has plural element groups, in each of which the plural light-emitting elements are arranged in a main scanning direction along a rotation axis of the photoreceptor, and each of the element groups includes: forward order arrangement in which the plural light-emitting elements are arranged such that positions thereof in a sub-scanning direction orthogonal to the main scanning direction are shifted from one end side to the other end side toward one side in the main scanning direction; and reverse order arrangement in which the plural light-emitting elements are arranged such that positions thereof in the sub-scanning direction are shifted from the other end side to the one end side toward the one side in the main scanning direction.

In the exposure device according to the present disclosure, each of the element groups may include two or more sets of either one of the forward order arrangement and the reverse order arrangement.

In the exposure device according to the present disclosure, an interval L in the sub-scanning direction may be set, the light-emitting elements may be arranged in m rows, and a distance between the light-emitting elements, which are adjacent in the main scanning direction, in the sub-scanning direction may be less than (m−1)× L.

In the exposure device according to the present disclosure, the plural element groups may have common arrangement of the plural light-emitting elements.

An image forming apparatus according to the present disclosure includes the exposure device according to the present disclosure.

According to the present disclosure, the plural light-emitting elements are arranged in one direction, folded in the middle, and arranged in a reverse direction. In this way, the plural light-emitting elements are arranged in a cyclic manner, it is possible to avoid the light-emitting elements from being arranged separately on a boundary between cycles. Then, the distance between the adjacent light-emitting elements in the sub-scanning direction is made as uniform as possible. As a result, it is possible to reduce density unevenness by suppressing a variation in an exposure time difference.

### BRIEF DESCRIPTION OF THE DRAWINGS

FIG. 1 is a schematic cross-sectional view illustrating an image forming apparatus according to a first embodiment of the present disclosure.

FIG. 2 is a schematic configuration diagram illustrating the image forming apparatus according to the first embodiment of the present disclosure.

FIG. 3 is a schematic plan view illustrating a panel member in a reference example.

FIG. 4 is a characteristic graph illustrating a relationship between an exposure time difference and density.

FIG. 5 is a schematic plan view illustrating a panel member in the first embodiment of the present disclosure.

FIG. 6 is a schematic plan view illustrating a panel member in a second embodiment of the present disclosure.

### DESCRIPTION OF THE PREFERRED EMBODIMENTS

### First Embodiment

Hereinafter, a description will be made on an image forming apparatus according to a first embodiment of the present disclosure with reference to the drawings.

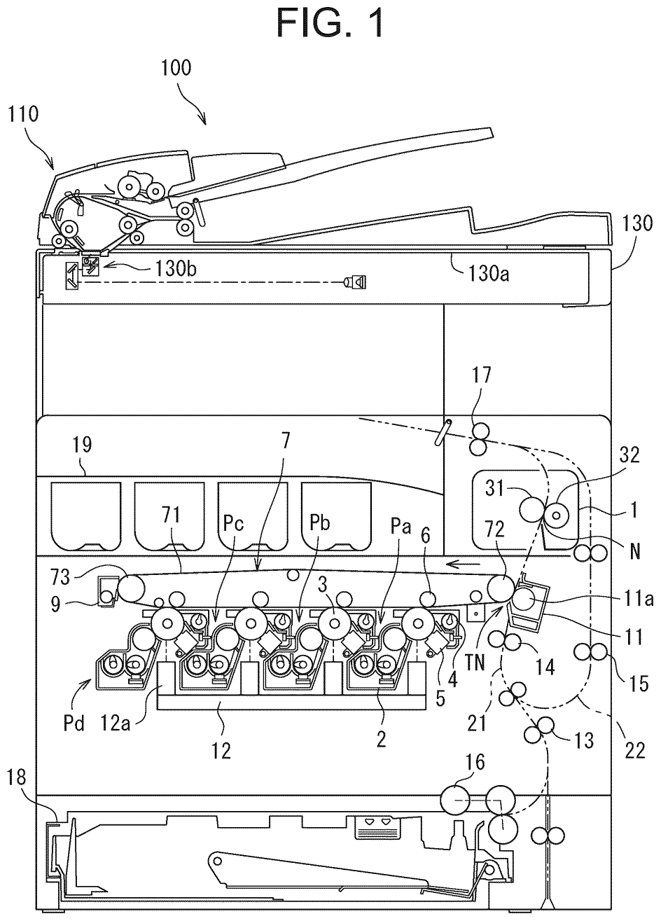

FIG. 1 is a schematic cross-sectional view illustrating the image forming apparatus according to the first embodiment of the present disclosure.

An image forming apparatus 100 is a multifunction peripheral that has a copier function, a scanner function, a facsimile function, and a printer function, sends an image of a document read by an image reader 130 to the outside, and forms the image of the document read by the image reader 130 or an image received from the outside on a recording medium such as a sheet of paper in color or in a single color.

A document conveyor 110 that is supported in a freely openable/closable manner is provided above the image reader 130. The document conveyor 110 sequentially conveys one or more sheets of the document one at a time. The image reader 130 scans and reads the document, which has been placed on a document placement table 130a, with a scanning optical system 130b or reads the document conveyed by the document conveyor 110 to generate image data.

The image forming apparatus 100 includes a fixing device 1, a developing device 2, a photoreceptor drum 3 (an example of a photoreceptor), a drum cleaner 4, a charger 5, an intermediate transfer belt device 7, a secondary transfer device 11, an exposure device 12, a paper feeder 18, and the like.

In the image forming apparatus 100, the image data corresponding to a color image using each color of black (K), cyan (C), magenta (M), and yellow (Y), or a monochrome image using a single color (for example, black). In the image forming apparatus 100, four each of the developing devices 2, the photoreceptor drums 3, the drum cleaners 4, and the chargers 5 are provided to form four types of toner images, each set thereof corresponds to respective one of black, cyan, magenta, and yellow, and four image stations Pa, Pb, Pc, Pd are thereby formed.

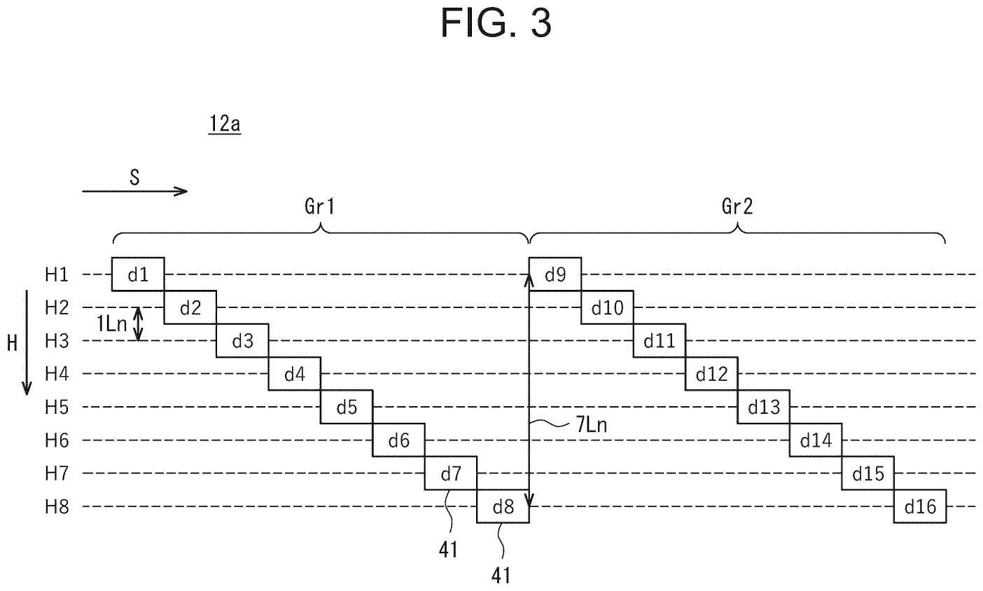

The charger 5 uniformly charges a surface of the respective photoreceptor drum 3 to a predetermined potential. The exposure device 12 has a panel member 12a that opposes the surface of the respective photoreceptor drum 3, and exposes the surface of the respective photoreceptor drum 3 to form an electrostatic latent image. The developing device 2 develops the electrostatic latent image on the surface of the respective photoreceptor drum 3 and forms the toner image on the surface of the respective photoreceptor drum 3. The drum cleaner 4 removes and collects residual toner from the surface of the respective photoreceptor drum 3. Through a series of above-described operations, the toner image in each color is formed on the surface of the respective photoreceptor drum 3. The panel members 12a will be described in detail with reference to FIG. 3.

The intermediate transfer belt device 7 includes an intermediate transfer roller 6, an endless intermediate transfer belt 71, an intermediate transfer drive roller 72, an intermediate transfer driven roller 73, and a cleaner 9. The four intermediate transfer rollers 6 are provided on an inner side of the intermediate transfer belt 71, so as to form four types of the toner images corresponding to the respective colors. The intermediate transfer rollers 6 each transfer the toner image in the respective color, which has been formed on the surface of the respective photoreceptor drum 3, onto the intermediate transfer belt 71 that circles.

The intermediate transfer belt 71 is stretched over the intermediate transfer drive roller 72 and the intermediate transfer driven roller 73. In the image forming apparatus 100, the toner images in the respective colors, which have been formed on the surfaces of the photoreceptor drums 3, are sequentially transferred and superimposed on each other to form the colored toner image on the surface of the intermediate transfer belt 71. The cleaner 9 removes and collects waste toner that is not transferred to a sheet and remains on the surface of the intermediate transfer belt 71.

The secondary transfer device 11 nips the sheet, which has been conveyed through a paper conveyance path 21, in a transfer nipper TN between secondary transfer rollers 11a and the intermediate transfer belt 71 to convey the sheet. When the sheet passes through the transfer nipper TN, the toner image on the surface of the intermediate transfer belt 71 is transferred and conveyed to the fixing device 1.

The fixing device 1 includes a fixing belt 31 and a pressure roller 32 that rotate about respective axes. The fixing device 1 nips the sheet, to which the toner image has been transferred, in a nipper N between the fixing belt 31 and the pressure roller 32, heats and pressurizes the sheet, and fixes the toner image to the sheet. Although not illustrated in FIG. 1, the fixing device 1 may have components other than the fixing belt 31 and the pressure roller 32.

The paper feeder 18 includes a paper feed cassette that loads the recording medium (the sheet) used for image formation, and is provided below the exposure device 12. The paper is pulled from the paper feeder 18 by a pickup roller 16 and transported to the paper conveyance path 21. The sheet, which has been conveyed to the paper conveyance path 21, passes through the secondary transfer device 11 and the fixing device 1, and is ejected into a paper ejection tray 19 by ejection rollers 17.

In the paper conveyance path 21, conveyance rollers 13, resist rollers 14, and the ejection rollers 17 are disposed. The conveyance rollers 13 facilitate conveyance of the sheet. The resist rollers 14 convey the sheet at the same speed as a process speed at which the image is formed on the sheet. These resist rollers 14 are provided between the paper feeder 18 and the secondary transfer device 11, and adjust paper conveyance timing such that the toner image is transferred to the sheet by the secondary transfer device 11. For example, the resist rollers 14 stand by (stop for a moment) while clamping the sheet conveyed from the paper feeder 18, and then starts conveying the sheet at a constant speed in synchronization with the secondary transfer device 11.

In a case where the image is formed not only a front side but also on a back side of the sheet, the ejection rollers 17 change a conveyance direction of the sheet, and the sheet is then conveyed to a reverse conveyance path 22. In the reverse conveyance path 22, reverse conveyance rollers 15 guide and convey the sheet, whose front and back sides are reversed, to the resist rollers 14. The image forming apparatus 100 forms the image on the back side of the sheet, which has been guided to the resist rollers 14, in the same manner as on the front side, and ejects the sheet into the paper ejection tray 19.

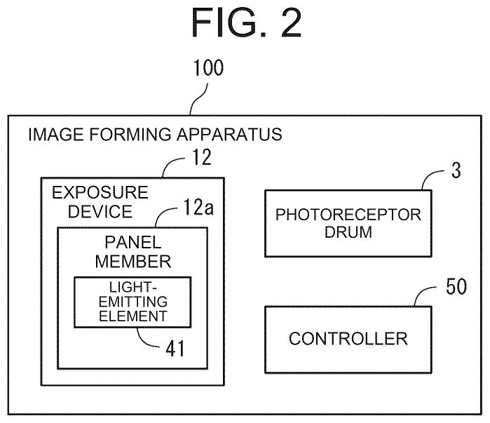

FIG. 2 is a schematic configuration diagram illustrating the image forming apparatus according to the first embodiment of the present disclosure. In FIG. 2, the image forming apparatus 100 is partially illustrated, and may appropriately include other members not illustrated in FIG. 2.

The panel member 12a includes plural light-emitting elements 41. The light-emitting element 41 is an organic EL diode (OLED) or a light-emitting diode (LED), for example. A controller 50 is a central processing unit (CPU) that is mounted on the image forming apparatus 100, and controls operation of the image forming apparatus 100. Here, the controller 50 may include one or plural control circuits.

FIG. 3 is a schematic plan view illustrating a panel member in a reference example.

In the exposure device 12, the four panel members 12a are provided in a manner to respectively oppose the four photoreceptor drums 3. The exposure device 12 may independently be provided for each of the photoreceptor drums 3, or the panel member 12a may be provided in a manner to correspond to each of the four photoreceptor drum 3. Since the four panel members 12a have substantially the same configuration, FIG. 3 schematically illustrates only one of the panel members 12a.

In the image forming apparatus 100, an axial direction along a rotation axis of the photoreceptor drum 3 is parallel to a width direction of the sheet on which the image is formed, and the photoreceptor drum 3 is configured to rotate about the rotation axis. The panel member 12a is a rectangular flat plate, a vertical direction (a main scanning direction S) thereof corresponds to the axial direction, and a short direction (a sub-scanning direction H) thereof corresponds to a rotational direction of the photoreceptor drum 3.

The panel member 12a in the reference example has plural element groups (a first element group Gr1 and a second element group Gr2), in each of which the plural light-emitting elements 41 are aligned in the main scanning direction S. FIG. 3 illustrates, as the panel member 12a, a configuration having the first element group Gr1 and the second element group Gr2, each of which includes the eight light-emitting elements 41. However, the panel member 12a is not limited thereto, and the number of the light-emitting elements 41 that constitute the element group or the number of the element groups provided in the panel member 12a may appropriately be changed. Hereinafter, in order to distinguish the plural light-emitting elements 41 from each other, the light-emitting elements 41 may be denoted by reference signs d1, d2, . . . , d16 in an order from one end side (a left end side in FIG. 3) to the other end side (a right end side in FIG. 3) in the main scanning direction S. That is, the first element group Gr1 includes the light-emitting elements 41 of d1 to d8, and the second element group Gr2 includes the light-emitting elements 41 of d9 to d16.

In the element group, the light-emitting elements 41 that are adjacent to each other in the main scanning direction S are disposed such that positions thereof in the sub-scanning direction H are shifted from one end side (an upper end side in FIG. 3) to the other end side (a lower end side in FIG. 3) toward one side in the main scanning direction S. Broken lines (a first line to an eighth line) H1 to H8 illustrated in FIG. 3 are parallel in the main scanning direction S, are arranged at constant intervals in the sub-scanning direction H, and indicate positions of the light-emitting elements 41 in the sub-scanning direction H. That is, it is indicated that the positions of the light-emitting elements 41 that are arranged on the same line overlap in the sub-scanning direction H.

In the panel member 12a illustrated in FIG. 3, the light-emitting element 41 of d1 is arranged on the first line (H1) located on the uppermost end side in FIG. 3, and the light-emitting element 41 of d2 is arranged on the second line (H2) that is shifted to the lower end side from the first line. Similarly, the light-emitting elements 41 of d3 onward are arranged to be sequentially shifted to the lower end side, and the light-emitting element 41 of d8 is arranged on the eighth line (H8) positioned on the lowermost end side in FIG. 3.

In the second element group Gr2, the same arrangement as that in the first element group Gr1 is repeated, and the light-emitting element 41 of d9 is arranged on the first line (H1). The light-emitting elements 41 of d10 onward are arranged to be sequentially shifted to the lower end side, and the light-emitting element 41 of d16 is arranged on the eighth line (H8).

As described above, in the same element group, a distance between the adjacent light-emitting elements 41, such as the light-emitting element 41 of d2 and the light-emitting element 41 of d3, in the sub-scanning direction H is a distance corresponding to one line (a one-line difference 1Ln). Meanwhile, on a boundary between the element groups, the distance between the adjacent light-emitting elements 41, such as the light-emitting element 41 of d8 and the light-emitting element 41 of d9, in the sub-scanning direction H is a distance corresponding to seven lines (a seven-line difference 7Ln).

In the exposure device 12, the light-emitting elements 41 are exposed to light in an order from an upstream side in the rotational direction of the photoreceptor drum 3, and exposure timing of the light-emitting elements 41 is controlled in accordance with the rotation of the photoreceptor drum 3. More specifically, in the configuration illustrated in FIG. 3, the light-emitting elements 41 on the first line (H1), that is, the light-emitting element 41 of d1 and the light-emitting element of d9 are located on the most upstream side in the rotational direction of the photoreceptor drum 3 and are exposed to the light first. Meanwhile, the light-emitting elements 41 on the eighth line (H8), that is, the light-emitting element 41 of d8 and the light-emitting element of 41 d16 are located on the most downstream side in the rotational direction of the photoreceptor drum 3 and are exposed to the light lastly.

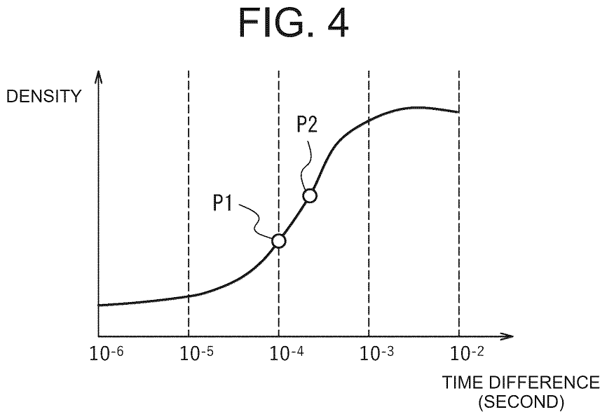

Here, when attention is paid to the light-emitting element 41 of d9, which is arranged at one end in the sub-scanning direction H, and the light-emitting element 41 of d8, which is arranged at the other end in the sub-scanning direction H, both thereof are arranged adjacently in the main scanning direction S. However, these light-emitting elements 41 are separated farthest in the sub-scanning direction H among the plural light-emitting elements 41, and there is a large time difference in the exposure timing. Since the significant increase in the difference of the exposure timing (exposure time difference) between adjacent pixels affects the density, a description thereon will be made with reference to FIG. 4.

FIG. 4 is a characteristic graph illustrating a relationship between the exposure time difference and the density.

In FIG. 4, a horizontal axis represents the exposure time difference between the adjacent pixels, and a vertical axis represents the density of the pixels. As described above, when there is the significant exposure time difference between the adjacent pixels, the density of the pixel may become high due to a phenomenon of reciprocity failure. In FIG. 4, a point P1 corresponds to the exposure time difference of the one-line difference 1Ln, a point P2 corresponds to the exposure time difference of the seven-line difference 7Ln, and the density of the point P2 is higher than that of the point P1. Even when an exposure amount and the like are set to obtain the same density, just as described, the intended density may not be obtained depending on the arrangement of the light-emitting elements 41.

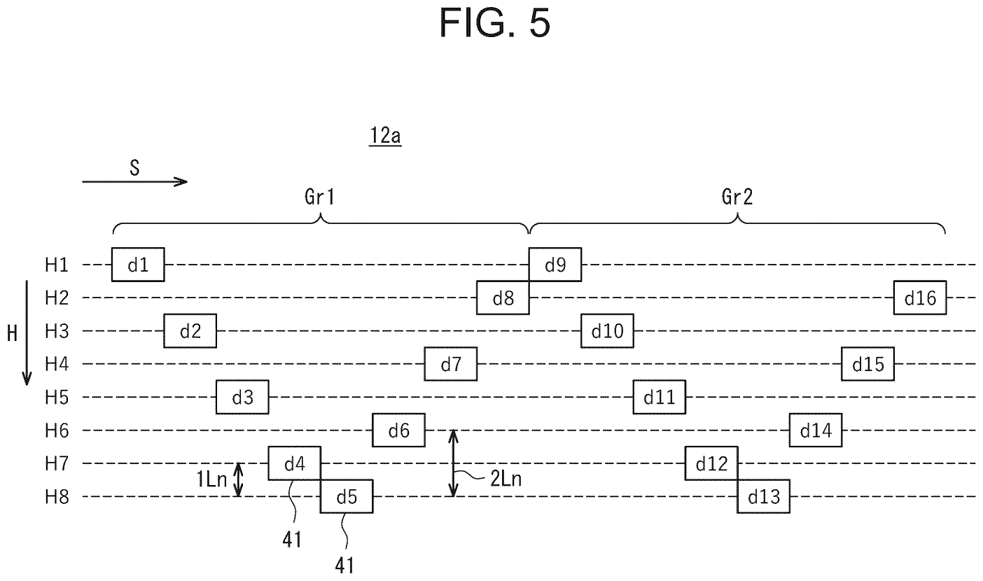

To handle such a problem, in the present embodiment, the density is adjusted to be appropriate by adjusting the arrangement of the light-emitting elements 41. Next, a description will be made on the arrangement of the light-emitting elements 41 on the panel member 12a in the present embodiment with reference to FIG. 5.

FIG. 5 is a schematic plan view illustrating the panel member in the first embodiment of the present disclosure.

Similar to FIG. 3, FIG. 5 schematically illustrates only the single panel member 12a. Also, in the present embodiment, the panel member 12a has the two element groups (the first element group Gr1 and the second element group Gr2), in each of which the plural light-emitting elements 41 are arranged in the main scanning direction S. Then, the first element group Gr1 includes the light-emitting elements 41 of d1 to d8, and the second element group Gr2 includes the light-emitting elements 41 of d9 to d16.

In the panel member 12a illustrated in FIG. 5, the light-emitting element 41 of d1 is arranged on the first line (H1), the light-emitting element 41 of d2 is arranged on a third line (H3) that is shifted to the lower end side from the first line, the light-emitting element 41 of d3 is arranged on a fifth line (H5) that is shifted to the lower end side from the third line, the light-emitting element 41 of d4 is arranged on a seventh line (H7) that is shifted to the lower end side of the fifth line, and the light-emitting element 41 of d5 is arranged on the eighth line (H8) that is shifted to the lower end side from the seventh line.

That is, the light-emitting elements 41 of d1 to d5 are arranged in a forward order such that the positions thereof in the sub-scanning direction H are shifted from one end side (an upper end side in FIG. 5) to the other end side (the lower end side in FIG. 5) toward one side (a right end side in FIG. 5) in the main scanning direction S.

Next, the light-emitting element 41 of d6 is arranged on a sixth line (H6) that is shifted to the upper end side from the eighth line, the light-emitting element 41 of d7 is arranged on a fourth line (H4) that is shifted to the upper end side from the sixth line, and the light-emitting element 41 of d8 is arranged on the second line (H2) that is shifted to the upper end side from the fourth line. The arrangement of the plural light-emitting elements 41 in the second element group Gr2 is common to that in the first element group Gr1, and the light-emitting elements 41 of d9 to d16 are arranged in the same manner as the light-emitting elements 41 of d1 to d8.

That is, the light-emitting elements 41 of d5 to d9 are arranged in a reverse order such that the positions thereof in the sub-scanning direction H are shifted from the other end side to the one end side toward the one side in the main scanning direction S.

In the present embodiment, when attention is paid to the distance between the adjacent light-emitting elements 41 in the sub-scanning direction H, for example, a distance between the light-emitting element 41 of d4 and the light-emitting element 41 of d5 in the sub-scanning direction H is a distance corresponding to one line (the one-line difference 1Ln), and such light-emitting elements are arranged at the narrowest interval. Meanwhile, a distance between the light-emitting element 41 of d5 and the light-emitting element 41 of d6 in the sub-scanning direction H is a distance corresponding to two lines (a two-line difference 2Ln), and such light-emitting elements are arranged at the widest interval.

In the reference example illustrated in FIG. 3, the distances between the light-emitting elements 41 include the one-line difference 1Ln and the seven-line difference 7Ln, and there is the large variation in the exposure time difference. Meanwhile, in the present embodiment, the narrowest interval is set to the one-line difference 1Ln, the widest interval is set to the two-line difference 2Ln, and the variation in the exposure time difference is reduced. Just as described, the plural light-emitting elements 41 are arranged in the one direction, folded in the middle, and then arranged in the reverse direction. In this way, when the plural light-emitting elements 41 are arranged in a cyclic manner, it is possible to avoid the light-emitting elements 41 from being arranged separately on a boundary between the cycles. In addition, the distance between the adjacent light-emitting elements 41 in the sub-scanning direction H is made as uniform as possible. As a result, it is possible to reduce density unevenness by suppressing the variation in the exposure time difference. Furthermore, the number of the light-emitting elements can easily be increased by repeating the common arrangement of the light-emitting elements 41 in the cyclic manner, and thus a degree of freedom in design can be improved.

In the panel member 12a, the number of rows in which the light-emitting elements 41 are arranged may appropriately be changed. For example, in the case where an interval L in the sub-scanning direction H is set, and the light-emitting elements 41 are arranged in m rows, the light-emitting elements 41 only needs to be arranged such that the distance between the light-emitting elements 41, which are adjacent in the main scanning direction S, in the sub-scanning direction H is less than (m−1)×L. As a result, it is possible to avoid the light-emitting elements 41, which are adjacent to each other in the main scanning direction S, from being arranged in the rows at both ends and to thereby avoid the light-emitting elements 41 from being arranged farthest from each other.

### Second Embodiment

Next, a description will be made on an image forming apparatus according to a second embodiment of the present disclosure with reference to the drawings.

In the second embodiment, the arrangement of the light-emitting elements 41 differs from that in the first embodiment. In the second embodiment, substantially the same configuration as that in the first embodiment illustrated in FIGS. 1 to 5 is provided. Thus, the description thereon will not be made and will be made only on differences.

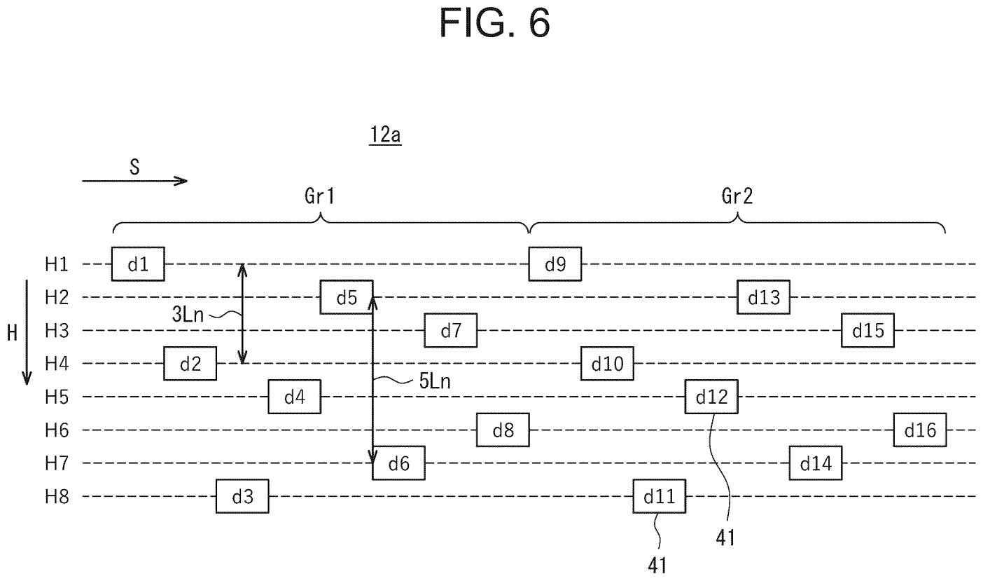

FIG. 6 is a schematic plan view illustrating a panel member in the second embodiment of the present disclosure.

Similar to FIG. 5, FIG. 6 schematically illustrates only the single panel member 12a. Also, in the present embodiment, the panel member 12a has the two element groups (the first element group Gr1 and the second element group Gr2), in each of which the plural light-emitting elements 41 are arranged in the main scanning direction S. Then, the first element group Gr1 includes the light-emitting elements 41 of d1 to d8, and the second element group Gr2 includes the light-emitting elements 41 of d9 to d16.

Next, on the panel member 12a illustrated in FIG. 6, the light-emitting element 41 of d1 is arranged on the first line, the light-emitting element 41 of d2 is arranged on the fourth line that is shifted to the lower end side from the first line, and the light-emitting element 41 of d3 is arranged on the eighth line that is shifted to the lower end side from the fourth line. That is, the light-emitting elements 41 of d1 to d3 are arranged in the forward order such that the positions thereof in the sub-scanning direction H are shifted from one end side (an upper end side in FIG. 6) to the other end side (a lower end side in FIG. 6) toward the one side (a right end side in FIG. 6) in the main scanning direction S.

Next, the light-emitting element 41 of d4 is arranged on the fifth line that is shifted to the upper end side from the eighth line, and the light-emitting element 41 of d5 is arranged on the second line that is shifted to the upper end side from the fifth line. That is, the light-emitting elements 41 of d3 to d5 are arranged in the reverse order such that the positions thereof in the sub-scanning direction H are shifted from the other end side to the one end side toward the one side in the main scanning direction S.

Then, the light-emitting element 41 of d6 is arranged on the sixth line that is shifted to the lower end side from the second line, the light-emitting element 41 of d7 is arranged on the third line that is shifted to the upper end side from the sixth line, and the light-emitting element 41 of d8 is arranged on the sixth line that is shifted to the lower end side from the third line. The arrangement of the plural light-emitting elements 41 in the second element group Gr2 is common to that in the first element group Gr1, and the light-emitting elements 41 of d9 to d16 are arranged in the same manner as the light-emitting elements 41 of d1 to d8.

When attention is paid to the light-emitting elements 41 of d5 to d9, the light-emitting elements 41 of d5, d6 are arranged in the forward order, the light-emitting elements 41 of d6, d7 are arranged in the reverse order, the light-emitting elements 41 of d7, d8 are arranged in the forward order, and the light-emitting elements 41 of d8, d9 are arranged in the reverse order.

In the present embodiment, when attention is paid to the distance between the adjacent light-emitting elements 41 in the sub-scanning direction H, for example, a distance between the light-emitting element 41 of d1 and the light-emitting element 41 of d2 in the sub-scanning direction H is a distance corresponding to three lines (a three-line difference 3Ln), and such light-emitting elements are arranged at the narrowest interval. In addition, the distance between the light-emitting element 41 of d5 and the light-emitting element 41 of d6 in the sub-scanning direction H is a distance corresponding to five lines (a five-line difference 5Ln), and such light-emitting elements are arranged at the widest interval.

In the present embodiment, two or more sets of either one of the forward order arrangement and the reverse order arrangement are provided in the single element group. The narrowest interval is set to the three-line difference 3Ln, and the widest interval is set to the five-line difference 5Ln. Then, by increasing the number of times of folding, the light-emitting elements 41 arranged in the manner to increase the distance therebetween while reducing the difference. As a result, by efficiently using the increase in the density due to the reciprocity failure, the overall density is increased, and the light amounts of the light-emitting elements 41 are reduced. In this way, low power consumption can be achieved.

The embodiments disclosed herein are illustrative in all respects and are not intended to be the basis for the limited interpretation. Accordingly, the technical scope of the present disclosure is not interpreted only by the embodiments described above, but is defined on the basis of the claims. The technical scope of the present disclosure includes all variations that are equivalent in meaning and scope to the claims.

What is claimed is:

1. An exposure device comprising:
a panel member that opposes a photoreceptor and has plural light-emitting elements, wherein
the panel member has plural element groups, in each of which the plural light-emitting elements are arranged in a main scanning direction along a rotation axis of the photoreceptor, and
each of the element groups includes:
forward order arrangement in which the plural light-emitting elements are arranged such that positions thereof in a sub-scanning direction orthogonal to the main scanning direction are shifted from one end side to the other end side toward one side in the main scanning direction; and
reverse order arrangement in which the plural light-emitting elements are arranged such that positions thereof in the sub-scanning direction are shifted from the other end side to the one end side toward the one side in the main scanning direction.

2. The exposure device according to claim 1, wherein
each of the element group includes two or more sets of either one of the forward order arrangement and the reverse order arrangement.

3. The exposure device according to claim 1, wherein
an interval L in the sub-scanning direction is set, and the plural light-emitting elements are arranged in m rows, and
a distance between the light-emitting elements, which are adjacent in the main scanning direction, in the sub-scanning direction is less than (m−1)×L.

4. The exposure device according to claim 1, wherein
the plural element groups have common arrangement of the plural light-emitting elements.

5. An image forming apparatus comprising:
the exposure device according to claim 1.
